(19) United States
(12) Patent Application Publication
(10) Pub. No.: US 2008/0266211 A1
(43) Pub. Date: Oct. 30, 2008

(54) Plasma Display Panel, Plasma Display Device, and Method for Driving Plasma Display Panel

(75) Inventors: Hiroyasu Makino, Osaka (JP); Toshikazu Wakabayshi, Osaka (JP); Hiroyuki Tachibana, Osaka (JP); Naoki Kosugi, Kyoto (JP); Kazuya Nomoto, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/097,379

(22) PCT Filed: Dec. 14, 2006
(86) PCT No.: PCT/JP2006/324944

§ 371 Date: Jun. 13, 2008

(30) Foreign Application Priority Data
Dec. 15, 2005 (JP) 2005-361568

(51) Int. Cl. G09G 3/28

(52) U.S. Cl. 345/60

(57) ABSTRACT

A priming discharge is generated simultaneously in two adjacent priming discharge cells, and an address operation is performed sequentially in the main discharge cells in the odd rows of the four rows of main discharge cells which are adjacent to the priming discharge cells. After completion of the address operation in all main discharge cells in the odd rows, the priming discharge cells are once initialized. A priming discharge is generated again in the priming discharge cells, and an address operation is performed sequentially this time in the main discharge cells in the even rows which are adjacent to the priming discharge cells. This provides a PDP and a plasma display device which can stably generate an address discharge without narrowing the driving voltage margin of an address operation and reduce the number of driving circuits required for driving the priming electrodes, and also provides a method for driving the PDP.

### TECHNICAL FIELD

The present invention relates to a plasma display panel and a plasma display device which are used for wall-mounted TVs, large-size monitors, and the like, and also relates to a method for driving the plasma display panel.

### BACKGROUND ART

A plasma display panel (hereinafter, abbreviated as “PDP” or “panel”) is a display device with the advantages of being large, thin, lightweight, and highly visible.

Such a panel is typified by the AC surface-discharge type panel including a large number of discharge cells between a front panel and a rear panel facing each other. The front panel includes a front glass substrate, display electrode pairs which are parallelly arranged on the substrate, and a dielectric layer and a protective layer which are formed in that order over the display electrode pairs. The display electrode pairs each consist of a scan electrode and a sustain electrode. The rear panel, on the other hand, includes a rear glass substrate, data electrodes which are parallelly arranged on the substrate, a dielectric layer which is formed over the data electrodes, and barrier ribs which are formed in parallel to the data electrodes. The surface of the dielectric layer and the side surfaces of the barrier ribs are covered with phosphor layers. The front panel and the rear panel are disposed opposite to each other and sealed in such a manner that the display electrode pairs and the data electrodes three-dimensionally intersect with each other. The front and rear panels have a discharge space therebetween filled with a discharge gas. In the panel with this structure, a gas discharge in each discharge cell generates ultraviolet light, which excites and illuminates R, G, and B phosphors to achieve color display.

The panel is generally driven by a sub-field method in which one field period is divided into a plurality of sub-fields, and a gradation display is achieved by selecting a combination of the sub-fields in which the phosphors are to be illuminated. Each sub-field includes an initializing period, an address period, and a sustain period.

In the initializing period, an initializing discharge is generated in all discharge cells simultaneously so as to delete the history of the wall charges remaining within the discharge cells and then to form wall charges necessary for a subsequent address operation. The initializing period also has the function of generating priming (discharge initiator=excited particles) in order to reduce the discharge delay, thereby stabilizing the generation of an address discharge. In the address period, selected ones of the scan electrodes are sequentially applied with a scan pulse voltage, and selected ones of the data electrodes are applied with an address pulse voltage corresponding to the image signal to be displayed. As a result, an address discharge is generated between the selected scan electrodes and the selected data electrodes, thereby selectively forming a wall charge. In the subsequent sustain period, a sustain pulse voltage is applied a predetermined number of times between the scan electrodes and the sustain electrodes, so that only the discharge cells that have formed wall charges by address discharges are selectively discharged for light emission.

To correctly display images on the PDP based on the image signal in this manner, it is crucial to ensure the selective address discharge in the address period. However, there are many factors to cause an increase in delay in the address discharge as follows. For example, the address pulse voltage cannot be high due to the circuit structure. The phosphor layers formed on the data electrodes prevent the generation of a discharge. The increasing PDP screen size in recent years extends the distance between the data electrodes, leading to an increase in the electrode resistance. Therefore, the priming, which allows the stable generation of an address discharge, is extremely important.

However, the amount of priming produced by a discharge rapidly decreases with time. Therefore, in the above-described panel driving method, an address discharge generated when a long period of time has elapsed after the initializing discharge is deficient in the priming produced by the initializing discharge, causing a large discharge delay. This makes the address operation unstable and the image display quality worse. As another problem, if the address time is set long to stabilize the address operation, the address period becomes too long.

To overcome this problem, there have been proposed PDPs having priming electrodes for generating a priming discharge which produces priming to reduce a discharge delay, and a method for driving such a PDP (see, for example, Patent Document 1 below).

The aforementioned PDP, however, has the following problems. First, adjacent discharge cells tend to cause mutual interference. In particular, in the address period, discharge cells may have address errors or address failures due to the influence of the address discharge in adjacent discharge cells. To avoid these inconveniences, the driving voltage margin of the address operation is set narrow. Furthermore, the priming electrodes are required to be driven independently of each other because a priming discharge is generated immediately before the address operation on each scan electrode. Therefore, the priming electrodes need to be driven by the same number of circuits.

Patent Document 1: Japanese Patent Unexamined Publication No. H09-245627

### SUMMARY OF THE INVENTION

The present invention provides a PDP and a plasma display device which can stably generate an address discharge without narrowing the driving voltage margin of an address operation and can also reduce the number of driving circuits required for driving priming electrodes; and also provides a method for driving the PDP.

The PDP of the present invention includes a scan electrode and a sustain electrode together a forming display electrode pair, the scan electrode and the sustain electrode being parallel to each other on a first substrate;

a priming electrode between adjacent to the scan electrodes of the display electrode pairs on the first substrate, the priming electrode being parallel to the display electrode pair; a data electrode on a second substrate, the second substrate facing the first substrate with a discharge space therebetween, the data electrode being in a direction intersecting with the display electrode pair; and a barrier rib defining a main discharge cell in a position where the display electrode pair and the data electrode face each other, the barrier rib also defining priming discharge cell in a position where the priming electrode and the data electrode face each other, wherein at least two adjacent ones of the priming electrodes are electrically connected to each other.

This structure provides a plasma display panel which can stably generate an address discharge without narrowing the driving voltage margin of an address operation and can also reduce the number of driving circuits required for driving the priming electrodes.

The plasma display device of the present invention includes a plasma display panel including: a scan electrode and a sustain electrode together forming display electrode pair, the scan electrode and the sustain electrode being parallel to each other on a first substrate; a priming electrode between adjacent to the scan electrodes of the display electrode pairs on the first substrate, the priming electrode being parallel to the display electrode pair; a data electrode on a second substrate, the second substrate facing the first substrate with a discharge space therebetween, the data electrode being in a direction intersecting with the display electrode pair; and a barrier rib defining main discharge cell in a position where the display electrode pair and the data electrode face each other, the barrier rib also defining priming discharge cell in a position where the priming electrode and the data electrodes face each other, wherein at least two adjacent ones of the priming electrodes are simultaneously applied with a priming pulse voltage.

This provides a plasma display device which can stably generate an address discharge without narrowing the driving voltage margin of an address operation and can also reduce the number of driving circuits required for driving the priming electrodes.

The method of the present invention for driving a PDP, the PDP including a scan electrode and a sustain electrode together forming a display electrode pair, the scan electrode and the sustain electrode being parallel to each other on a first substrate; a priming electrode between adjacent to the scan electrodes of the display electrode pairs on the first substrate, the priming electrode being parallel to the display electrode pair; a data electrode on a second substrate, the second substrate facing the first substrate with a discharge space therebetween, the data electrode being in a direction intersecting with the display electrode pair; and a barrier rib defining a main discharge cell in a position where the display electrode pair and the data electrode face each other, the barrier rib also defining a priming discharge cell in a position where the priming electrode and the data electrode face each other, the method for driving the PDP in which one field includes a plurality of sub-fields each having an initializing period, an address period, and a sustain period, the method including: applying a priming pulse voltage simultaneously to at least two adjacent ones of the priming electrodes in the address period; and generating a priming discharge simultaneously in the at least two adjacent priming discharge cells.

This provides a method for driving a PDP which can stably generate an address discharge without narrowing the driving voltage margin of an address operation and can also reduce the number of driving circuits required for driving priming electrodes.

The method for driving a plasma display panel may include the following steps: generating an address discharge sequentially to the main discharge cells in odd rows or in even rows, of at least four rows of main discharge cells adjacent to the at least two priming discharge cells that have generated a priming discharge; generating a priming discharge again in the at least two priming discharge cells that have generated the priming discharge; and generating an address discharge sequentially in the main discharge cells where the address discharge are not generated. This method can reduce the number of the driving circuits required for driving the priming electrodes and stably generate an address discharge.

The method for driving a plasma display panel may include the step of generating an address discharge sequentially in at least four main discharge cells adjacent to the at least two priming discharge cells that have generated the priming discharge. This method can reduce the number of the driving circuits required for driving the priming electrodes and generate an address discharge more efficiently and stably.

As described above, the present invention provides a PDP and a plasma display device which can stably generate an address discharge without narrowing the driving voltage margin of an address operation and can also reduce the number of driving circuits required for driving the priming electrodes, and further provides a method for driving the PDP.

### BRIEF DESCRIPTION OF PREFERRED EMBODIMENTS

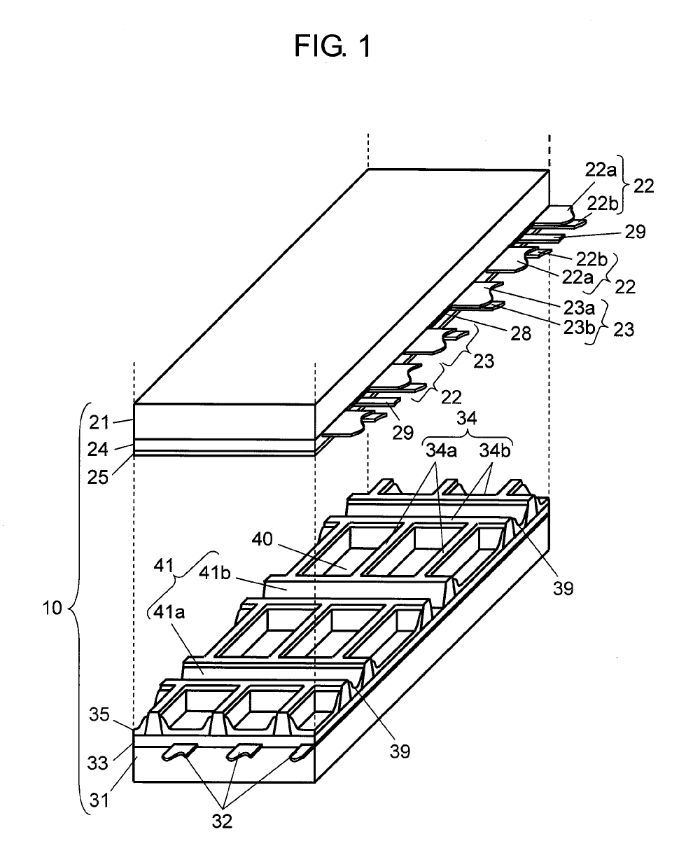

FIG. 1 is an exploded perspective view of a PDP according to a first embodiment of the present invention.

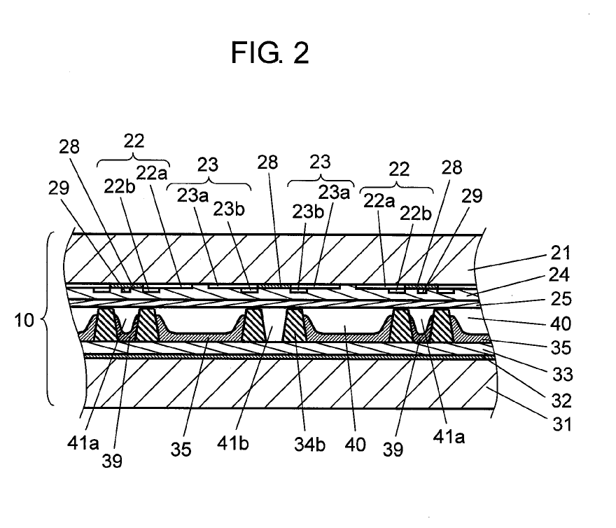

FIG. 2 is a sectional view of the PDP.

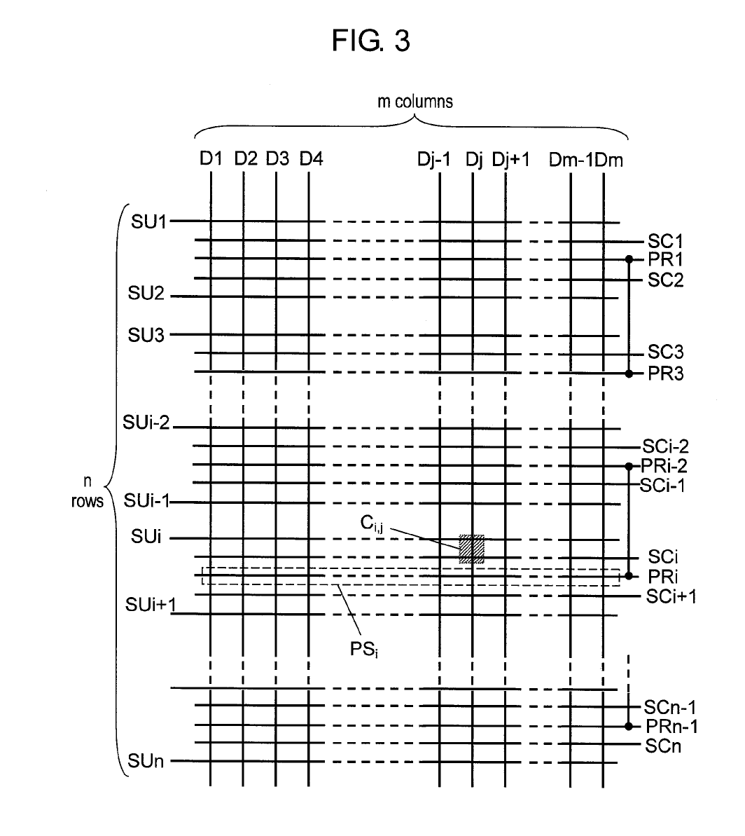

FIG. 3 is an electrode array of the PDP.

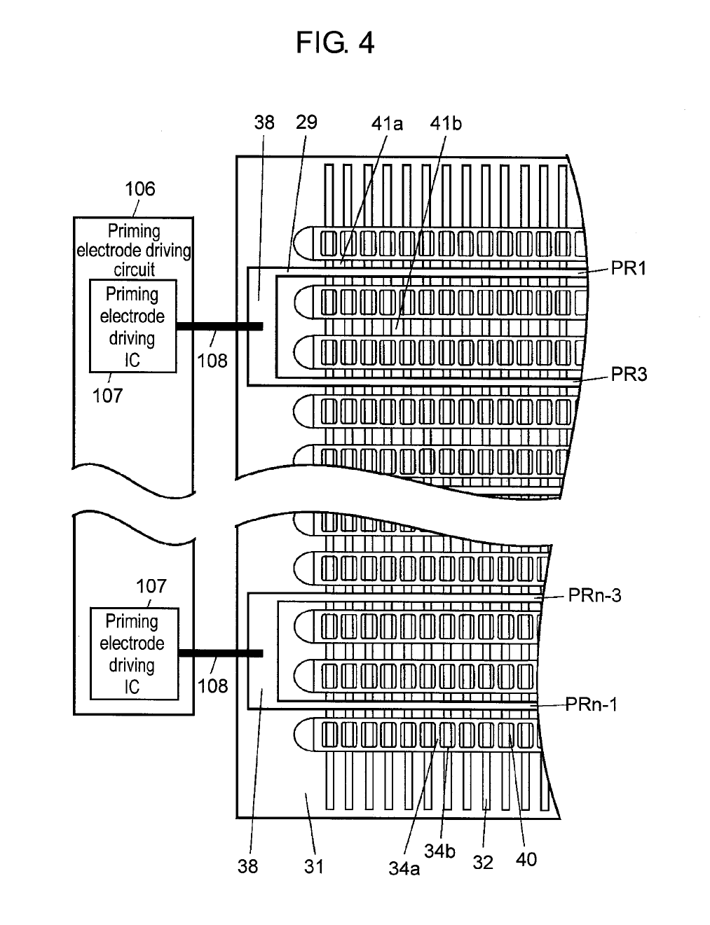

FIG. 4 is a plan view showing the connection between priming electrodes and a priming electrode driving circuit of the PDP.

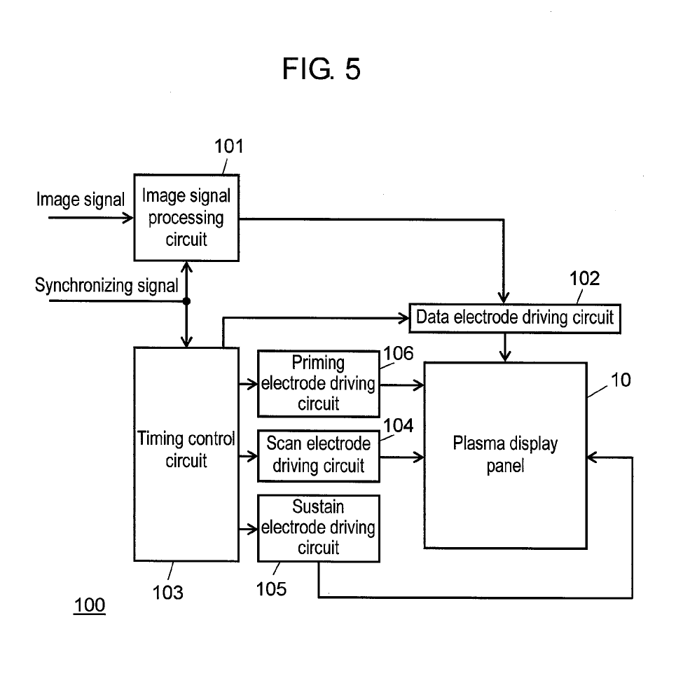

FIG. 5 is a block diagram showing a plasma display device using the PDP.

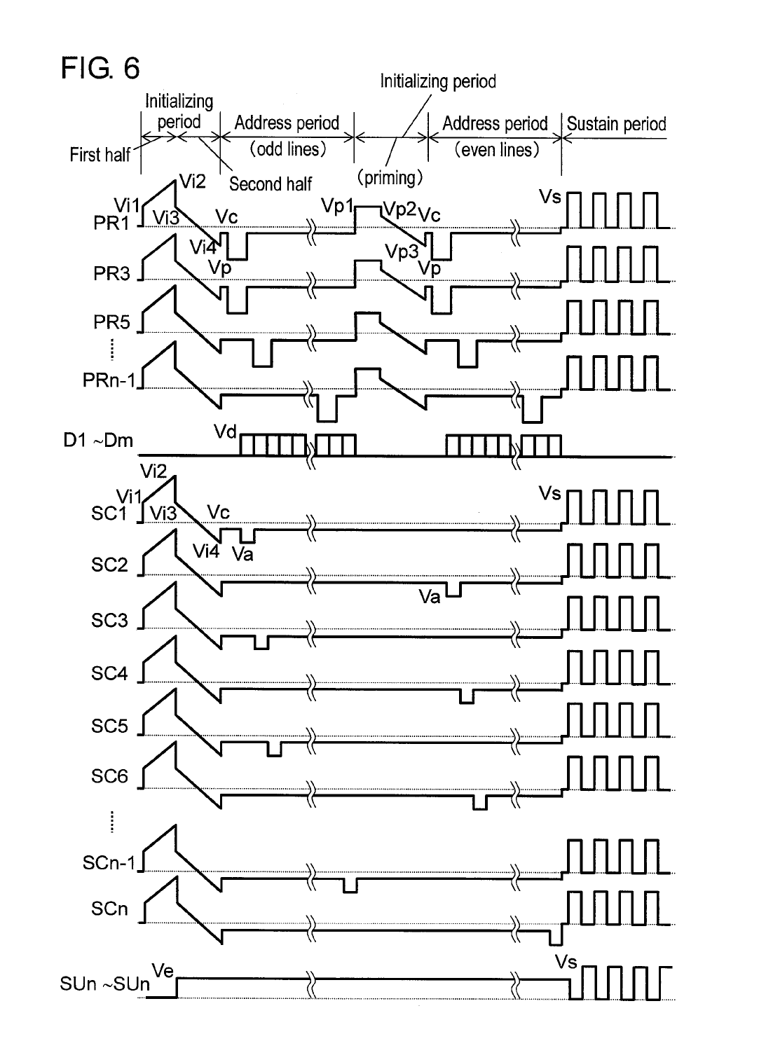

FIG. 6 is a driving waveform diagram of the PDP.

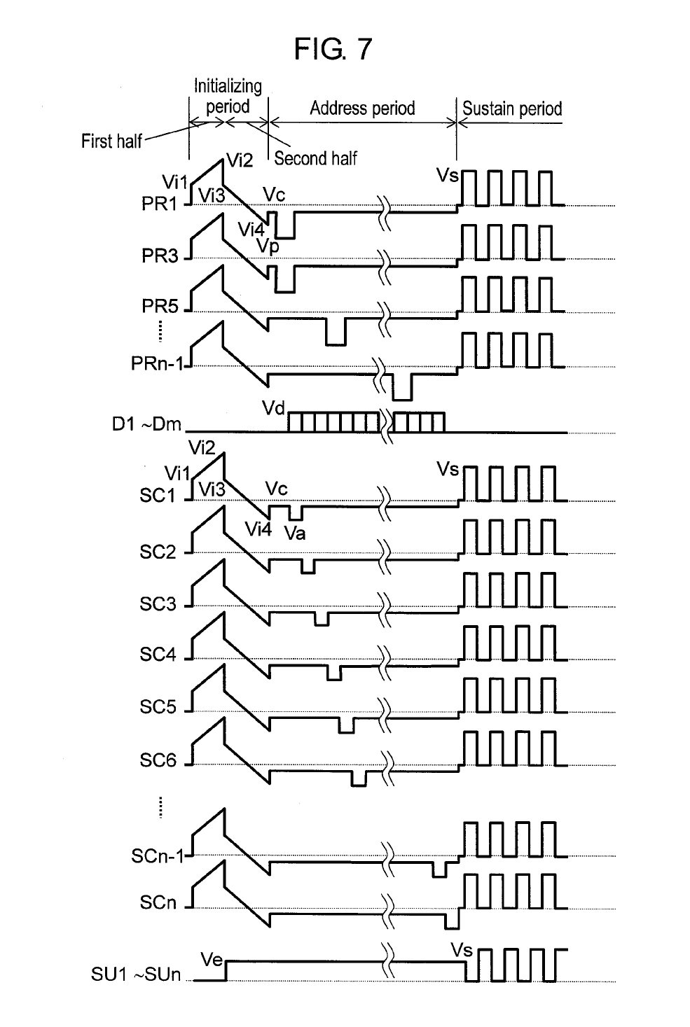

FIG. 7 is a driving waveform diagram showing another example of the method for driving the PDP.

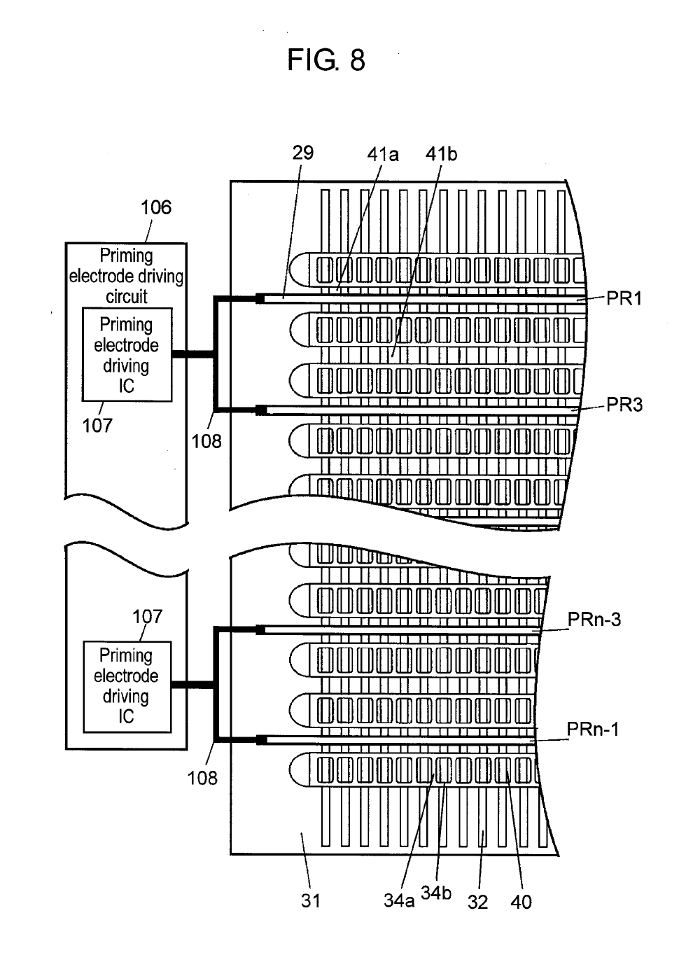

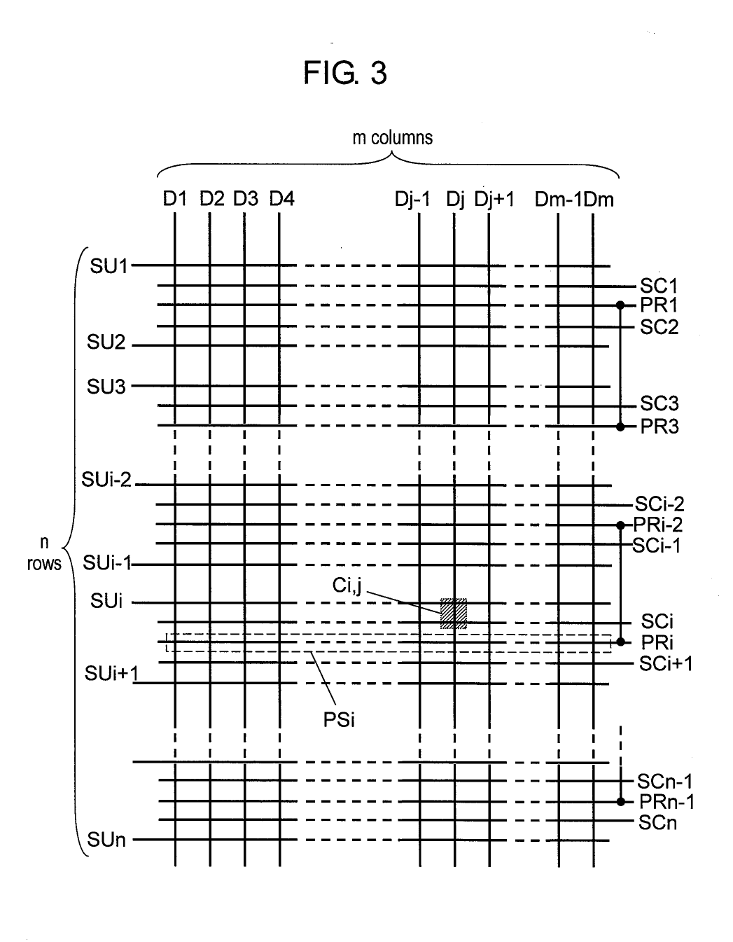

FIG. 8 is a plan view showing the connection between priming electrodes and a priming electrode driving circuit of another example of the PDP.

### REFERENCE MARKS IN THE DRAWINGS

10 PDP (plasma display panel)
21 front substrate
22 scan electrode
22a, 23a transparent electrode
22b, 23b metal bus bar
23 sustain electrode
24, 33 dielectric layer
25 protective layer
28 light-absorbing layer
29 priming electrode
31 rear substrate
32 data electrode
34 barrier rib
34a longitudinal rib part
34b lateral rib part
35 phosphor layer
38 connecting portion
39 MgO powder layer
40 main discharge cell
41, 41b gap
41a priming discharge cell
100 plasma display device
101 image signal processing circuit
102 data electrode driving circuit
103 timing control circuit
104 scan electrode driving circuit
105 sustain electrode driving circuit
106 priming electrode driving circuit
107 priming electrode driving IC
108 conductive line

### DETAILED DESCRIPTION OF PREFERRED EMBODIMENT

A PDP, a plasma display device, and a method for driving the PDP according to an embodiment of the present invention are described as follows with reference to drawings.

### First Embodiment

FIG. 1 is an exploded perspective view of PDP 10 according to a first embodiment of the present invention, and FIG. 2 is a sectional view of PDP 10.

As shown in FIGS. 1 and 2, PDP 10 includes front substrate 21 as a first substrate made of glass and rear substrate 31 as a second substrate which face each other with a discharge space therebetween. The discharge space is filled with a mixed gas of neon (Ne) and xenon (Xe), which emits ultraviolet light when a discharge occurs.

Front substrate 21 is provided thereon with parallel-arranged display electrode pairs each consisting of scan electrode 22 and sustain electrode 23. In the present first embodiment, a display electrode pair in the order of scan electrode 22 and sustain electrode 23 is sandwiched between two display electrode pairs in the order of sustain electrode 23 and scan electrode 22. Between two adjacent scan electrode 22 is provided priming electrode 29 in parallel with the display electrode pairs. More specifically, front substrate 21 has electrodes arranged thereon in the following order: sustain electrode 23, scan electrode 22, priming electrode 29, scan electrode 22, sustain electrode 23, sustain electrode 23, scan electrode 22, priming electrode 29, scan electrode 22, sustain electrode 23 . . . .

Scan electrodes 22 are each formed of transparent electrode 22a and metal bus bar 22b formed thereon. Sustain electrodes 23 are each formed of transparent electrode 23a and metal bus bar 23b formed thereon. Between two adjacent scan electrodes 22 and between two adjacent sustain electrodes 23 is provided light-absorbing layer 28 made of a black material. Priming electrodes 29 are metal bus bars formed on light-absorbing layers 28 between two adjacent scan electrodes 22. Scan electrodes 22, sustain electrodes 23, priming electrodes 29, and light-absorbing layers 28 are covered with dielectric layer 24 and protective layer 25 in that order.

Rear substrate 31 is provided thereon with data electrodes 32 parallelly arranged in the direction intersecting with scan electrodes 22 and also provided with dielectric layer 33 covering data electrodes 32. Dielectric layer 33 is provided thereon with barrier ribs 34 defining main discharge cells 40 in positions where the display electrode pairs and data electrodes 32 face each other, and also defining priming discharge cells 41a in positions where priming electrodes 29 and data electrodes 32 face each other.

Barrier ribs 34 include longitudinal rib parts 34a and lateral rib parts 34b. Longitudinal rib parts 34a extend parallel to data electrodes 32. Lateral rib parts 34b form main discharge cells 40 and also form gaps 41 between main discharge cells 40. Consequently, barrier ribs 34 form rows of main discharge cells 40 along a display electrode pair consisting of scan electrode 22 and sustain electrode 23. Barrier ribs 34 also form gaps 41 between adjacent rows of the main discharge cells. Of all gaps 41, gaps 41 that are formed in areas where two scan electrodes 22 are adjacent to each other correspond to priming electrodes 29 of front substrate 21, and these gaps 41 function as priming discharge cells 41a. Gaps 41 also include gaps 41b formed in areas where two sustain electrodes 23 are adjacent to each other. Thus, gaps 41 are formed of priming discharge cells 41a having priming electrodes 29 and gaps 41b arranged alternately with each other.

Barrier ribs 34 have flat tops to be in contact with front substrate 21. This prevents the mutual interference of adjacent main discharge cells 40 and particularly prevents malfunctions in the address period, such as address errors due to the influence of the discharge in adjacent main discharge cells 40. This also prevents main discharge cells 40 adjacent to priming discharge cells 41a from decreasing their wall charges due to the priming discharge and thus causing malfunctions such as address failures.

The surface of dielectric layer 33 in areas corresponding to main discharge cells 40 defined by barrier ribs 34 and the side surfaces of barrier ribs 34 are covered with phosphor layers 35.

In the present first embodiment, priming discharge cells 41a are applied with MgO powder layer 39 in order to decrease their starting voltage when the discharge space is filled with the mixed gas of neon (Ne) and xenon (Xe). MgO powder layer 39 is made of a material based on MgO, which is field proven as material for AC type PDPs and has a large secondary electron emission coefficient and excellent durability. MgO powder layer 39 has the function of effectively discharging secondary electrons into priming discharge cells 41a when a voltage is applied between priming electrodes 29 and data electrodes 32. As a result, secondary electrons can be supplied uniformly into priming discharge cells 41a from MgO powder layer 39 formed continuously in the longitudinal direction of priming discharge cells 41a. This reduces variations in the priming discharge in priming discharge cells 41a having long and narrow shapes, thereby generating a uniform priming discharge in main discharge cells 40. In addition, this facilitates the generation of a priming discharge, thereby reducing a voltage to be applied to the priming discharge.

MgO powder layer 39 may be replaced by other materials such as conductive materials, or metal oxides having a large secondary electron emission coefficient as long as it can reduce the starting voltage. The materials having a large secondary electron emission coefficient include alkali metal oxides (such as Cs₂O), alkaline earth metal oxides (such as MgO, CaO, SrO, and BaO), rare earth oxides (such as Y₂O₃, La₂O₃, CeO₂, Er₂O₃, and Lu₂O₃), and fluorides (such as LiF, CaF₂, and MgF₂).

It is not always necessary to apply MgO powder layer 39 to priming discharge cells 41a if the starting voltage can be reduced by other means. For example, the starting voltage can be reduced by reducing the discharge distance between priming electrodes 29 and data electrodes 32 in priming discharge cells 41a.

Dielectric layer 33, which is provided to cover data electrodes 32 in the present embodiment, is not an essential component. Phosphor layers 35, which are not provided on gaps 41 as shown in FIGS. 1 and 2, may alternatively be provided thereon. MgO powder layer 39 is applied to priming discharge cells 41a and not to gaps 41b as shown in FIGS. 1 and 2, but may alternatively be applied to gaps 41b as well.

FIG. 3 is an electrode array of PDP 10 according to the first embodiment of the present invention. FIG. 4 is a plan view showing the connection between priming electrodes 29 and a priming electrode driving circuit of PDP 10.

As shown in FIG. 3, PDP 10 includes m-column data electrodes D1 to Dm (data electrodes 32 of FIG. 1) in the column direction. PDP 10 further includes n-row scan electrodes SC1 to SCn (scan electrodes 22 of FIG. 1), n-row sustain electrodes SU1 to SUn (sustain electrodes 23 of FIG. 1), and n/2-row priming electrodes PR1 to PRn−1 (priming electrodes 29 of FIG. 1) in the row direction. These electrodes are arranged in the following order: sustain electrode SU1, scan electrode SC1, priming electrode PR1, scan electrode SC2, sustain electrode SU2, sustain electrode SU3, scan electrode SC3, priming electrode PR3, scan electrode SC4, sustain electrode SU4, . . . . The discharge space includes m×n main discharge cells Ci, j (main discharge cells 40 of FIG. 1) each including one pair of scan electrode SC1 and sustain electrode SU1 (i=1 to n) and one data electrode Dj (j=1 to m). The discharge space further includes n/2 priming discharge cells PSp (priming discharge cells 41a of FIG. 1) each including priming electrode PRp (p is an odd number) and data electrodes D1 to Dm. In the address period, the priming produced in priming discharge cell PSp is supplied to main discharge cells Cp, 1 to Cp, m and Cp+1, 1 to Cp+1, m which are adjacent to priming discharge cell PSp.

As shown in FIG. 4, priming electrode driving circuit 106 includes a plurality of priming electrode driving ICs 107, which are electrically connected to priming electrodes 29 via conductive lines 108. Priming electrode driving ICs 107 output a priming pulse voltage to be applied to priming electrodes 29 via conductive lines 108. In the present first embodiment, adjacent priming electrodes PRp and PRp+2, such as priming electrodes PR1 and PR3 or priming electrodes PR5 and PR7 are electrically connected to each other via connecting portions 38. This establishes an electrical connection between one priming electrode driving IC 107 and two priming electrodes PRp and PRp+2, so that one priming electrode driving IC 107 can apply a priming pulse voltage to two priming electrodes PRp and PRp+2 simultaneously.

As a result, two adjacent priming discharge cells 41a with main discharge cell 40, gap 41b, and main discharge cell 40 disposed in that order therebetween can generate a priming discharge simultaneously.

FIG. 5 is a block diagram showing a plasma display device using PDP 10 according to the first embodiment of the present invention. Plasma display device 100 includes image signal processing circuit 101, data electrode driving circuit 102, scan electrode driving circuit 104, sustain electrode driving circuit 105, priming electrode driving circuit 106, and timing control circuit 103. Image signal processing circuit 101 generates a sub-field signal based on an image signal and a synchronizing signal received. Data electrode driving circuit 102 drives data electrodes 32, scan electrode driving circuit 104 drives scan electrodes 22, sustain electrode driving circuit 105 drives sustain electrodes 23, and priming electrode driving circuit 106 drives priming electrodes 29. Timing control circuit 103 generates timing control signals for controlling these driving circuits based on a synchronizing signal received.

More specifically, image signal processing circuit 101 generates the sub-field signal for controlling the on-off of each pixel in each sub-field based on the image signal and the synchronizing signal received, and then outputs the sub-field signal to data electrode driving circuit 102. Timing control circuit 103 outputs the timing control signal to data electrode driving circuit 102, scan electrode driving circuit 104, sustain electrode driving circuit 105, and priming electrode driving circuit 106 based on the synchronizing signal received.

Data electrode driving circuit 102 applies a predetermined driving waveform voltage to data electrodes 32 (data electrodes D1 to Dm of FIG. 3) of PDP 10 based on the sub-field signal and the timing control signal received. Scan electrode driving circuit 104 applies a predetermined driving waveform voltage to scan electrodes 22 (scan electrodes SC1 to SCn of FIG. 3) of PDP 10 based on the timing control signal received. Sustain electrode driving circuit 105 applies a predetermined driving waveform voltage to sustain electrodes 23 (sustain electrodes SU1 to SUn of FIG. 3) of PDP 10 based on the timing control signal received.

Priming electrode driving circuit 106 includes priming electrode driving ICs 107 which are half the number of priming electrodes 29. One priming electrode driving IC 107 is electrically connected to two priming electrodes 29 so as to drive them simultaneously. Priming electrode driving circuit 106 applies the predetermined driving waveform voltage to priming electrodes 29 (priming electrodes PR1 to PRn−1 of FIG. 3) of PDP 10 based on the timing control signal received. Data electrode driving circuit 102, scan electrode driving circuit 104, sustain electrode driving circuit 105, and priming electrode driving circuit 106 are supplied with necessary power from a power supply circuit (unillustrated).

The following is a description of driving waveforms and their timings to drive PDP 10 according to the first embodiment of the present invention, together with the operation of PDP 10. FIG. 6 is a driving waveform diagram of PDP 10. One field period consists of a plurality of sub-fields each having an initializing period, an odd-line address period, a priming discharge cell initializing period (shown as “initializing period (priming)” in FIG. 6), an even-line address period, and a sustain period. In the first embodiment of the present invention, in the initializing period of the first sub-field in a field, an all-cell initializing operation is performed to generate an initializing discharge in all main discharge cells 40 involved in a screen display. In the initializing period of the second and subsequent sub-fields, a selective initializing operation is performed to generate an initializing discharge selectively only in main discharge cells 40 that have performed a sustain discharge in the sustain period of the immediately preceding sub-field. For convenience, the all-cell initializing period is divided into the first half and the second half.

As shown in FIG. 6, in the first half of the initializing period of the first sub-field of a field, data electrodes D1 to Dm and sustain electrodes SU1 to SUn are held at 0V. Scan electrodes SC1 to SCn are applied with a ramp voltage gradually increasing from voltage Vi1 to voltage Vi2. At voltage Vi2, each of the voltage difference between scan electrodes SC1 to SCn and sustain electrodes SU1 to SUn and the voltage difference between scan electrodes SC1 to SCn and data electrodes D1 to Dm exceeds the starting voltage. Priming electrodes PR1 to PRn−1 are applied with the same ramp voltage as scan electrodes SC1 to SCn. As a result, in main discharge cells Ci, j, a weak initializing discharge is generated between scan electrodes SC1 to SCn and sustain electrodes SU1 to SUn and between scan electrodes SC1 to SCn and data electrodes D1 to Dm. In priming discharge cells 41a, a weak initializing discharge is generated between priming electrodes PR1 to PRn−1 and data electrodes D1 to Dm. Consequently, a negative wall voltage is accumulated on scan electrodes SC1 to SCn and on priming electrodes PR1 to PRn−1, whereas a positive wall voltage is accumulated on data electrodes D1 to Dm and on sustain electrodes SU1 to SUn. The wall voltage on electrodes indicates the voltage generated by wall charges accumulated, for example, on protective layer 25 and phosphor layers 35 covering these electrodes.

In the second half of the initializing period, sustain electrodes SU1 to SUn are held at positive voltage Ve. Scan electrodes SC1 to SCn are applied with a ramp voltage gradually decreasing from voltage Vi3 to voltage Vi4, which exceeds the starting voltage. At voltage Vi3, each of the voltage difference between scan electrodes SC1 to SCn and sustain electrodes SU1 to SUn and the voltage difference between scan electrodes SC1 to SCn and data electrodes D1 to Dm is equal to or more than the starting voltage. Priming electrodes PR1 to PRn−1 are applied with the same ramp voltage as scan electrodes SC1 to SCn. As a result, a weak initializing discharge is generated between scan electrodes SC1 to SCn and sustain electrodes SU1 to SUn, between scan electrodes SC1 to SCn and data electrodes D1 to Dm, and between priming electrodes PR1 to PRn−1 and data electrodes D1 to Dm. This reduces the negative wall voltage on scan electrodes SC1 to SCn and the positive wall voltage on sustain electrodes SU1 to SUn. The positive wall voltage on data electrodes D1 to Dm is adjusted to a value suitable for the subsequent address operation, and the wall voltage on priming electrodes PR1 to PRn−1 is adjusted to a value suitable for the priming operation. In this manner, the all-cell initializing operation to generate an initializing discharge in all the discharge cells involved in the screen display is complete.

In the subsequent odd-line address period, scan electrodes SC1 to SCn and priming electrodes PR1 to PRn−1 are once held at Vc. The reason for this is to prevent unwanted discharge from being generated by the application of later-described address pulse voltage Vd. Priming electrode PR1 in the first row and priming electrode PR3 in the third row are applied with negative priming pulse voltage Vp simultaneously. This allows a priming discharge to be generated between priming electrode PR1 and data electrodes D1 to Dm and between priming electrode PR3 and data electrodes D1 to Dm, that is, in priming discharge cells PS1 and PS3, whether data electrodes D1 to Dm are applied with an address pulse or not.

In this structure, the priming discharge cells are applied with MgO powder layer 39 having a large secondary electron emission coefficient. This allows the generation of a stable discharge at a low voltage so as to reduce variations in the starting voltage, thereby increasing the operating margin. The generation of the discharge at a low voltage can reduce discharge intensity and also prevent the influence of the discharge in priming discharge cells 41a to the others, such as crosstalk. In the case where the discharge voltage is the same as the conventional level, the discharge operating margin can be larger than in the conventional case. The applied voltage can be adjusted to achieve both a decrease in crosstalk and an increase in the operating margin. As a result, a high-definition PDP has further stable address performance.

The priming discharge supplies priming to main discharge cells C1, 1 to C1, m in the first row; main discharge cells C2, 1 to C2, m in the second row; main discharge cells C3, 1 to C3, m in the third row; and main discharge cells C4, 1 to C4, m in the fourth row. As a result, a positive wall voltage is accumulated on priming electrodes PR1 and PR3.

Next, negative scan pulse voltage Va is applied to scan electrode SC1 in the first row. At the same time as this, positive address pulse voltage Vd is applied to data electrode Dk (indicating a data electrode selected based on the video signal from data electrodes D1 to Dm) corresponding to the image signal to be displayed in the first row. As a result, an address discharge is generated in main discharge cell C1, k at the intersection of data electrode Dk applied with address pulse voltage Vd and scan electrode SC1 applied with scan pulse voltage Va. The address discharge allow a positive wall voltage to be accumulated on scan electrode SC1 and a negative wall voltage to be accumulated on sustain electrode SU1 in main discharge cell C1, k, thereby terminating the address operation in main discharge cells C1, 1 to C1, m in the first row. The address discharge in main discharge cell C1, k is stably performed with a short discharge delay because it is generated after completion of the supply of priming produced by the priming discharge between priming electrode PR1 and data electrodes D1 to Dm.

In the first embodiment of the present invention, the period of applying priming pulse voltage Vp to priming electrodes PR1 and PR3 and the period of applying scan pulse voltage Va to scan electrode SC1 in the first row partially overlap with each other. The reason for this is to perform the address operation in main discharge cells C1, 1 to C1, m in the first row and main discharge cells C3, 1 to C3, m in the third row as soon as possible after the generation of a priming discharge. The address operation in main discharge cells C1, 1 to C1, m in the first row is not substantially affected by the partial overlap between the periods. In the present first embodiment, the priming pulse width is set to two to three times the address pulse width. In addition, priming electrode driving circuit 106 for driving electrodes PR1 to PRn−1 is independent of the other driving circuits. This makes it possible to arbitrarily set the timing to apply the priming pulse voltage, the priming pulse width, and other conditions, thereby achieving the aforementioned driving.

Next, scan pulse voltage Va is applied to scan electrode SC3 in the third row. At the same time as this, positive address pulse voltage Vd is applied to data electrode Dk corresponding to the image signal to be displayed in the third row, of data electrodes D1 to Dm. As a result, an address discharge is generated in main discharge cell C3, k at the intersection of data electrode Dk applied with address pulse voltage Vd and scan electrode SC3 applied with scan pulse voltage Va. The address discharge allows a positive wall voltage to be accumulated on scan electrode SC3 and a negative wall voltage to be accumulated on sustain electrode SU3 in main discharge cell C3, k, thereby terminating the address operation in main discharge cells C3, 1 to C3, m in the third row. The address discharge in main discharge cell C3, k is also stably performed with a short discharge delay because it is generated after completion of the supply of priming produced by the priming discharge between priming electrode PR3 and data electrodes D1 to Dm.

Next, prior to the application of scan pulse voltage Va to scan electrode SC5 in the fifth row, negative priming pulse voltage Vp is applied simultaneously to priming electrodes PR5 and PR7 in the fifth and seventh rows, respectively. This allows a priming discharge to be generated between priming electrode PR5 and data electrodes D1 to Dm and between priming electrode PR7 and data electrodes D1 to Dm, that is, in priming discharge cells PS5 and PS7, whether data electrodes D1 to Dm are applied with an address pulse or not. The priming discharge supplies priming to main discharge cells C5, 1 to C5, m in the fifth row; main discharge cells C6, 1 to C6, m in the sixth row; main discharge cells C7, 1 to C7, m in the seventh row; and main discharge cells C8, 1 to C8, m in the eighth row. As a result, a positive wall voltage is accumulated on priming electrodes PR5 and PR7.

In the same manner as described above, negative scan pulse voltage Va is applied to scan electrode SC5 in the fifth row. At the same time as this, positive address pulse voltage Vd is applied to data electrode Dk corresponding to the image signal to be displayed in the fifth row, of data electrodes D1 to Dm. As a result, an address discharge is generated in main discharge cell C5, k. The address discharge allows a positive wall voltage to be accumulated on scan electrode SC5 and a negative wall voltage to be accumulated on sustain electrode SU5 in main discharge cell C5, k, thereby terminating the address operation in main discharge cells C5, 1 to C5, m in the fifth row. The address discharge in main discharge cell C5, k is also stably performed with a short discharge delay because it is generated after completion of the supply of priming produced by the priming discharge between priming electrode PR5 and data electrodes D1 to Dm.

The period of applying priming pulse voltage Vp to priming electrodes PR5 and PR7 and the period of applying scan pulse voltage Va to scan electrode SC5 in the fifth row partially overlap with each other. The reason for this is to perform the address operation in main discharge cells C5, 1 to C5, m in the fifth row and main discharge cells C7, 1 to C7, m in the seventh row as soon as possible after the generation of a priming discharge. The address operation in main discharge cells C5, 1 to C5, m in the fifth row is not substantially affected by the partial overlap between the periods.

Subsequently, scan pulse voltage Va is applied to scan electrode SC7 in the seventh row. At the same time as this, positive address pulse voltage Vd is applied to data electrode Dk corresponding to the image signal to be displayed in the seventh row, of data electrodes D1 to Dm. As a result, an address discharge is generated in main discharge cell C7, k, thereby terminating the address operation in main discharge cells C7, 1 to C7, m in the seventh row.

Next, prior to the application of scan pulse voltage Va to scan electrode SC9 in the ninth row, negative priming pulse voltage Vp is applied simultaneously to priming electrodes PR9 and PR11 in the ninth and eleventh rows, respectively. Hereafter, the address operation and the generation of a priming discharge are repeated for all the remaining main discharge cells in the odd rows.

Thus, in the first embodiment of the present invention, priming pulse voltage Vp is applied to two adjacent priming electrodes PRp and PRp+2 simultaneously to generate a priming discharge in priming discharge cells PSp and PSp+2. Consequently, an address discharge is sequentially generated in main discharge cells Cp, k and Cp+2, k in odd rows, which are adjacent to priming discharge cells PSp and PSp+2. Then, prior to the application of scan pulse voltage Va to scan electrode SCp+4 in the p+4 row, priming pulse voltage Vp is applied to priming electrodes PRp+4 and PRp+6. The address operation is repeated for all the main discharge cells in the odd rows. The address discharge in main discharge cells Ci, j is stably performed with a short discharge delay because it is generated after completion of the supply of priming from the adjacent priming discharge cells.

After the odd-line address period is over, a priming discharge cell initializing operation is performed prior to the address operation in the even lines so as to readjust the wall charge in priming discharge cells PS1 to PSn−1. In the priming discharge cell initializing period, first of all, voltage Vp1 is applied to priming electrodes PR1 to PRn−1 so as to generate a discharge in priming discharge cells PS1 to PSn−1. Consequently, a negative wall voltage is accumulated on priming electrodes PR1 to PRn−1, whereas a positive wall voltage is accumulated on data electrodes D1 to Dm in priming discharge cells PS1 to PSn−1.

Next, priming electrodes PR1 to PRn−1 are applied with a ramp voltage gradually decreasing from voltage Vp2 to voltage Vp3, which exceeds the starting voltage. At voltage Vp2, the voltage difference between priming electrodes PR1 to PRn−1 and data electrodes D1 to Dm is equal to or not more than the starting voltage. As a result, a weak initializing discharge is generated between priming electrodes PR1 to PRn−1 and data electrodes D1 to Dm. The negative wall voltage on priming electrodes PR1 to PRn−1 and the positive wall voltage on data electrodes D1 to Dm are adjusted to values suitable for the priming operation in the subsequent address period. The discharge generated in priming discharge cells PS1 to PSn−1 does not substantially affect the wall voltages in main discharge cells Cp, 1 to Cp, m.

In the even-line address period, scan electrodes SC1 to SCn and priming electrodes PR1 to PRn−1 are once held at Vc. The reason for this is to prevent unwanted discharge from being generated by the application of address pulse voltage Vd in the same manner as in the odd-line address period. Priming electrode PR1 in the first row and priming electrode PR3 in the third row are applied with negative priming pulse voltage Vp simultaneously in the same manner as in the odd-line address period. This allows a priming discharge to be generated between priming electrode PR1 and data electrodes D1 to Dm and between priming electrode PR3 and data electrodes D1 to Dm, that is, in priming discharge cells PS1 and PS3, whether data electrodes D1 to Dm are applied with an address pulse or not. The priming discharge supplies priming to main discharge cells C1, 1 to C1, m in the first row; main discharge cells C2, 1 to C2, m in the second row; main discharge cells C3, 1 to C3, m in the third row; and main discharge cells C4, 1 to C4, m in the fourth row. As a result, a positive wall voltage is accumulated on priming electrodes PR1 and PR3.

Next, negative scan pulse voltage Va is applied to scan electrode SC2 in the second row. At the same time as this, positive address pulse voltage Vd is applied to data electrode Dk corresponding to the image signal to be displayed in the second row, of data electrodes D1 to Dm. As a result, an address discharge is generated in main discharge cell C2, k at the intersection of data electrode Dk applied with address pulse voltage Vd and scan electrode SC2 applied with scan pulse voltage Va. The address discharge allows a positive wall voltage to be accumulated on scan electrode SC2 and a negative wall voltage to be accumulated on sustain electrode SU2 in main discharge cell C2, k, thereby terminating the address operation in main discharge cells C2, 1 to C2, m in the second row. The address discharge in main discharge cell C2, k is stably performed with a short discharge delay because it is generated after completion of the supply of priming produced by the priming discharge between priming electrode PR1 and data electrodes D1 to Dm.

The period of applying priming pulse voltage Vp to priming electrodes PR1 and PR3 and the period of applying scan pulse voltage Va to scan electrode SC2 in the second row partially overlap with each other. The reason for this is to perform the address operation in main discharge cells C2, 1 to C2, m in the second row and main discharge cells C4, 1 to C4, m in the fourth row as soon as possible after the generation of a priming discharge. The address operation in main discharge cells C2, 1 to C2, m in the second row is not substantially affected by the partial overlap between the periods.

Next, scan pulse voltage Va is applied to scan electrode SC4 in the fourth row. At the same time as this, positive address pulse voltage Vd is applied to data electrode Dk corresponding to the image signal to be displayed in the fourth row, of data electrodes D1 to Dm. As a result, an address discharge is generated in main discharge cell C4, k at the intersection of data electrode Dk applied with address pulse voltage Vd and scan electrode SC4 applied with scan pulse voltage Va. The address discharge allows a positive wall voltage to be accumulated on scan electrode SC4 and a negative wall voltage to be accumulated on sustain electrode SU4 in main discharge cell C4, k, thereby terminating the address operation in main discharge cells C4, 1 to C4, m in the fourth row. The address discharge in main discharge cell C4, k is also stably performed with a short discharge delay because it is generated after completion of the supply of priming produced by the priming discharge between priming electrode PR3 and data electrodes D1 to Dm.

Next, prior to the application of scan pulse voltage Va to scan electrode SC6 in the sixth row, negative priming pulse voltage Vp is applied simultaneously to priming electrodes PR5 and PR7 in the fifth and seventh rows, respectively. This allows a priming discharge to be generated between priming electrode PR5 and data electrodes D1 to Dm and priming electrode PR7 and data electrodes D1 to Dm, that is, in priming discharge cells PS5 and PS7, whether data electrodes D1 to Dm are applied with an address pulse or not. The priming discharge supplies priming to main discharge cells C5, 1 to C5, m in the fifth row; main discharge cells C6, 1 to C6, m in the sixth row; main discharge cells C7, 1 to C7, m in the seventh row; and main discharge cells C8, 1 to C8, m in the eighth row. As a result, a positive wall voltage is accumulated on priming electrodes PR5 and PR7.

In the same manner as described above, negative scan pulse voltage Va is applied to scan electrode SC6 in the sixth row. At the same time as this, positive address pulse voltage Vd is applied to data electrode Dk corresponding to the image signal to be displayed in the sixth row, of data electrodes D1 to Dm. As a result, an address discharge is generated in main discharge cell C6, k. The address discharge allows a positive wall voltage to be accumulated on scan electrode SC6 and a negative wall voltage to be accumulated on sustain electrode SU6 in main discharge cell C6, k, thereby terminating the address operation in main discharge cells C6, 1 to C6, m in the sixth row. The address discharge in main discharge cell C6, k is also stably performed with a short discharge delay because it is generated after completion of the supply of priming produced by the priming discharge between priming electrode PR6 and data electrodes D1 to Dm.

The period of applying priming pulse voltage Vp to priming electrodes PR5 and PR7 and the period of applying scan pulse voltage Va to scan electrode SC6 in the sixth row partially overlap with each other. The reason for this is to perform the address operation in main discharge cells C6, 1 to C6, m in the sixth row and main discharge cells C8, 1 to C8, m in the eighth row as soon as possible after the generation of a priming discharge. The address operation in main discharge cells C6, 1 to C6, m in the sixth row is not substantially affected by the partial overlap between the periods.

Subsequently, scan pulse voltage Va is applied to scan electrode SC8 in the eighth row. At the same time as this, positive address pulse voltage Vd is applied to data electrode Dk corresponding to the image signal to be displayed in the eighth row, of data electrodes D1 to Dm. As a result, an address discharge is generated in main discharge cell C8, k, thereby terminating the address operation in main discharge cells C8, 1 to C8, m in the eighth row.

Next, prior to the application of scan pulse voltage Va to scan electrode SC10 in the tenth row, negative priming pulse voltage Vp is applied simultaneously to priming electrodes PR9 and PR11 in the ninth and eleventh rows, respectively. Hereinafter, the address operation and the generation of a priming discharge are repeated for all the remaining main discharge cells in the even rows.

Thus, in the first embodiment of the present invention, priming pulse voltage Vp is applied to two adjacent priming electrodes PRp and PRp+2 simultaneously to generate a priming discharge in priming discharge cells PSp and PSp+2. Consequently, an address discharge is sequentially generated in main discharge cells Cp+1, k and Cp+3, k in even rows, which are adjacent to priming discharge cells PSp and PSp+2. Next, prior to the application of scan pulse voltage Va to scan electrode SCp+4 in the p+4 row, priming pulse voltage Vp is applied to priming electrodes PRp+4 and PRp+6. The address operation is repeated for all the remaining main discharge cells in the even rows. The address discharge in main discharge cells Ci, j is stably performed with a short discharge delay because it is generated after completion of the supply of priming from the adjacent priming discharge cells. In this manner, in the first embodiment of the present invention, the address operation in the main discharge cells is performed in the main discharge cells in the odd rows first, and then in the main discharge cells in the even rows.

In the first embodiment of the present invention, priming pulse voltage Vp and scan pulse voltage Va may have the same value. Alternatively, the priming pulse width and the scan pulse width may be equal to each other, so that scan pulse voltage Va is applied to scan electrode SCp+2 in the p+2 row at the same time as priming pulse voltage Vp is applied to priming electrodes PRp+4 and PRp+6.

In the subsequent sustain period, scan electrodes SC1 to SCn, priming electrodes PR1 to PRn−1, and sustain electrodes SU1 to SUn are once returned to 0V. Later, positive sustain pulse voltage Vs is applied to scan electrodes SC1 to SCn. At this moment, the voltage between on scan electrode SC1 and on sustain electrode SU1 in main discharge cells Ci, j that have generated an address discharge exceeds a starting voltage and generates a sustain discharge. This is because the voltage is a sum of the wall voltage accumulated on scan electrode SC1 and sustain electrode SU1 in the address period and sustain pulse voltage Vs. Hereinafter, a sustain pulse voltage is applied alternately to scan electrodes SC1 to SCn and sustain electrodes SU1 to SUn. As a result, a sustain discharge is continued the number of sustain pulses in main discharge cells Ci, j that have generated an address discharge.

In the initializing period (unillustrated) of the subsequent sub-field, sustain electrodes SU1 to SUn are held at positive voltage Ve, and scan electrodes SC1 to SCn and priming electrodes PR1 to PRn−1 are applied with a ramp voltage gradually decreasing to voltage Vi4. As a result, a weak initializing discharge is generated between scan electrodes SC1 to SCn and sustain electrodes SU1 to SUn and between scan electrodes SC1 to SCn and data electrodes D1 to Dm in main discharge cells Ci, k that have performed a sustain discharge, and also between priming electrodes PR1 to PRn−1 and data electrodes D1 to Dm. This reduces the wall voltage on scan electrodes SC1 to SCn and the wall voltage on sustain electrodes SU1 to SUn. The positive wall voltage on data electrodes D1 to Dm is adjusted to a value suitable for the address operation, and the positive wall voltage on priming electrodes PR1 to PRn−1 is adjusted to a value suitable for the priming operation.

The odd-line address period, the priming discharge cell initializing period, the even-line address period, the sustain period, the driving waveforms in the subsequent sub-fields, and the operation of PDP 10 are all identical to those described above.

In the initializing period and the sustain period, priming electrodes PR1 to PRn−1 are applied with nearly the same driving waveform voltage as scan electrodes SC1 to SCn. The reason for this is to prevent unwanted discharge from being generated between scan electrodes SCp, SCp+1 and priming electrode PRp due to their closeness to each other. There are cases where a discharge unrelated to a screen display is generated in a priming discharge cell when a first pulse voltage is applied in the address period and the sustain period. However, light-absorbing layer 28 provided in the priming discharge cells makes it very unlikely to leak the light produced at this moment to the outside of PDP 10. Even if the light leaks, its influence on images can be substantially ignored. In the address period, the address discharge in main discharge cells Ci, j is stably performed with a short discharge delay because it is generated after completion of the supply of priming produced by adjacent priming discharge cells.

There is no need to provide a period for a priming discharge except for the priming discharge in the first and third rows. This is because there is a partial overlap between the period of applying scan pulse voltage Va and the period of applying priming pulse voltage Vp. The partial overlap is provided, for example, between the period of applying scan pulse voltage Va to scan electrode SC3 and the period of applying priming pulse voltage Vp to priming electrodes PR5 and PR7, or between the period of applying scan pulse voltage Va to scan electrode SC7 and the period of applying priming pulse voltage Vp to priming electrodes PR9 and PR11. This enables the generation of a priming discharge without extending the time required to drive the panel.

Thus, in the first embodiment of the present invention, a priming discharge is generated simultaneously in two priming discharge cells PSp and PSp+2. As a result, priming is supplied to four rows of main discharge cells Cp, 1 to Cp, m; Cp+1, 1 to Cp+l, m; Cp+2, 1 to Cp+2, m; and Cp+3, 1 to Cp+3, m which are adjacent to priming discharge cells PSp and PSp+2. First, an address operation is performed in main discharge cells in the odd rows (an address operation in main discharge cells Cp, 1 to Cp, m and Cp+2, 1 to Cp+2, m). Then, a priming discharge is generated in the next two priming discharge cells PSp+4 and PSp+6 simultaneously, and an address operation is sequentially performed in the main discharge cells in the odd rows which are adjacent to the priming discharge cells. The generation of a priming discharge and the address operation are repeated for all the remaining main discharge cells in the odd rows. When the address operation in the main discharge cells in the odd rows is over, priming discharge cells PS1 to PSn−1 are once initialized. A priming discharge is generated again in two priming discharge cells PSp and PSp+2, and an address operation is sequentially performed this time in the main discharge cells in the even rows (an address operation in main discharge cells Cp+1, 1 to Cp+1, m and Cp+3, 1 to Cp+3, m) which are adjacent to the priming discharge cells. Then, a priming discharge is generated in the next two priming discharge cells PSp+4 and PSp+6 simultaneously, and an address operation is performed in the main discharge cells in the even rows which are adjacent to the priming discharge cells. The generation of a priming discharge and the address operation are repeated for all the remaining main discharge cells in the even rows.

In the first embodiment of the present invention, such a driving is performed for the following reason. The priming supplied to the main discharge cells is rapidly reduced with time by a priming discharge. The inventors of the present invention have conducted experiments to determine the residue time of the priming supplied to the main discharge cells by a single priming discharge. The residue time means the time period during which the amount of priming is enough to generate an address discharge that can be stably performed with a short discharge delay. The experimental results indicate that the amount of priming remaining in the main discharge cells is enough for the period corresponding to at least two address pulses.

For another reason, the number of priming electrode driving ICs 107 can be reduced if one priming electrode driving IC 107 can drive a plurality of priming electrodes 29.

Therefore, in the first embodiment of the present invention, one priming electrode driving IC 107 drives two priming discharge cells PSp and PSp+2 by the aforementioned panel driving method based on the experimental results. The experimental results indicate as described above that the amount of priming remaining in the main discharge cells is enough for the period corresponding to at least two address pulses. This allows the generation of an address discharge with a short discharge delay, without narrowing the driving voltage margin of an address operation. In addition, the number of priming electrode driving ICs 107 can be reduced to half the number of priming electrodes 29.

In the panel driving method according to the first embodiment described with FIG. 6, the address operation is performed in the main discharge cells in the odd rows first, and then in the main discharge cells in the even rows.

Alternatively, the address operation may be performed in the main discharge cells in the even rows first, and then in the main discharge cells in the odd rows so as to produce the same effect.

This panel driving method is the case where the amount of priming remaining in the main discharge cells is enough for the period corresponding to at least two address pulses. Alternatively, when the amount of priming remaining in the main discharge cells is enough for the period corresponding to at least four address pulses, the panel driving method can be as follows.

FIG. 7 is a driving waveform diagram showing another example of the method for driving PDP 10 according to the first embodiment of the present invention. In the driving waveform diagram of FIG. 7, each of the plurality of sub-fields in one field period includes an initializing period, an address period, and a sustain period. However, unlike the driving waveform diagram of FIG. 6, the address period is not divided into the odd-line address period and the even-line address period, and there is not provided a priming discharge cell initializing period. The driving waveform diagram of FIG. 7 has features identical to those of the diagram of FIG. 6 as follows. In the initializing period of the first sub-field in a field, an all-cell initializing operation is performed to generate an initializing discharge in all main discharge cells 40 involved in a screen display. In the initializing period of the second and subsequent sub-fields, a selective initializing operation is performed to generate an initializing discharge selectively only in main discharge cells 40 that have performed a sustain discharge in the sustain period of the immediately preceding sub-field. The initializing period and the sustain period have the same driving waveforms as those in FIG. 6. Therefore, the following description is focused on the address period. Note that the scan pulse width, scan pulse voltage Va, the priming pulse width, and priming pulse voltage Vp in the address period are identical to those of FIG. 6.

As shown in FIG. 7, in the address period, scan electrodes SC1 to SCn and priming electrodes PR1 to PRn−1 are once held at Vc. Priming electrode PR1 in the first row and priming electrode PR3 in the third row are applied with negative priming pulse voltage Vp simultaneously. This allows a priming discharge to be generated between priming electrode PR1 and data electrodes D1 to Dm and between priming electrode PR3 and data electrodes D1 to Dm, that is, in priming discharge cells PS1 and PS3, whether data electrodes D1 to Dm are applied with an address pulse or not.

The priming discharge supplies priming to main discharge cells C1, 1 to C1, m in the first row; main discharge cells C2, 1 to C2, m in the second row; main discharge cells C3, 1 to C3, m in the third row; and main discharge cells C4, 1 to C4, m in the fourth row. As a result, a positive wall voltage is accumulated on priming electrodes PR1 and PR3.

Next, negative scan pulse voltage Va is applied to scan electrode SC1 in the first row. At the same time as this, positive address pulse voltage Vd is applied to data electrode Dk (indicating a data electrode selected based on the video signal from data electrodes D1 to Dm) corresponding to the image signal to be displayed in the first row. As a result, an address discharge is generated in main discharge cell C1, k at the intersection of data electrode Dk applied with address pulse voltage Vd and scan electrode SC1 applied with scan pulse voltage Va. The address discharge allow a positive wall voltage to be accumulated on scan electrode SC1 and a negative wall voltage to be accumulated on sustain electrode SU1 in main discharge cell C1, k, thereby terminating the address operation in main discharge cells C1, 1 to C1, m in the first row.

Next, scan pulse voltage Va is applied to scan electrode SC2 in the second row. At the same time as this, positive address pulse voltage Vd is applied to data electrode Dk corresponding to the image signal to be displayed in the second row, of data electrodes D1 to Dm. As a result, an address discharge is generated in main discharge cell C2, k at the intersection of data electrode Dk applied with address pulse voltage Vd and scan electrode SC2 applied with scan pulse voltage Va. The address discharge allows a positive wall voltage to be accumulated on scan electrode SC2 and a negative wall voltage to be accumulated on sustain electrode SU2 in main discharge cell C2, k, thereby terminating the address operation in main discharge cells C2, 1 to C2, m in the second row.

Next, scan pulse voltage Va is applied to scan electrode SC3 in the third row. At the same time as this, positive address pulse voltage Vd is applied to data electrode Dk corresponding to the image signal to be displayed in the third row, of data electrodes D1 to Dm. As a result, an address discharge is generated in main discharge cell C3, k at the intersection of data electrode Dk applied with address pulse voltage Vd and scan electrode SC3 applied with scan pulse voltage Va. The address discharge allows a positive wall voltage to be accumulated on scan electrode SC3 and a negative wall voltage to be accumulated on sustain electrode SU3 in main discharge cell C3, k, thereby terminating the address operation in main discharge cells C3, 1 to C3, m in the third row.

Next, scan pulse voltage Va is applied to scan electrode SC4 in the fourth row. At the same time as this, positive address pulse voltage Vd is applied to data electrode Dk corresponding to the image signal to be displayed in the fourth row, of data electrodes D1 to Dm. As a result, an address discharge is generated in main discharge cell C4, k at the intersection of data electrode Dk applied with address pulse voltage Vd and scan electrode SC4 applied with scan pulse voltage Va. The address discharge allows a positive wall voltage to be accumulated on scan electrode SC4 and a negative wall voltage to be accumulated on sustain electrode SU4 in main discharge cell C4, k, thereby terminating the address operation in main discharge cells C4, 1 to C4, m in the fourth row.

The address discharge in main discharge cells C1, k to C4, k is also stably performed with a short discharge delay because, as described above, it is generated after completion of the supply of priming produced by the priming discharge between priming electrodes PR1 to PR4 and data electrodes D1 to Dm.

Next, prior to the application of scan pulse voltage Va to scan electrode SC5 in the fifth row, negative priming pulse voltage Vp is applied simultaneously to priming electrodes PR5 and PR7 in the fifth and seventh rows, respectively. This allows a priming discharge to be generated between priming electrode PR5 and data electrodes D1 to Dm and between priming electrode PR7 and data electrodes D1 to Dm, that is, in priming discharge cells PS5 and PS7, whether data electrodes D1 to Dm are applied with an address pulse or not. The priming discharge supplies priming to main discharge cells C5, 1 to C5, m in the fifth row; main discharge cells C6, 1 to C6, m in the sixth row; main discharge cells C7, 1 to C7, m in the seventh row; and main discharge cells C8, 1 to C8, m in the eighth row. As a result, a positive wall voltage is accumulated on priming electrodes PR5 and PR7. The period of applying priming pulse voltage Vp to priming electrodes PR5 and PR7 and the period of applying scan pulse voltage Va to scan electrode SC5 in the fifth row partially overlap with each other. The reason for this is to perform the address operation in the main discharge cells in the fifth and subsequent rows as soon as possible after the generation of a priming discharge. The address operation in main discharge cells C5, 1 to C5, m in the fifth row is not substantially affected by the partial overlap between the periods.

Next, negative scan pulse voltage Va is sequentially applied to scan electrode SC5 in the fifth row, scan electrode SC6 in the sixth row, scan electrode SC7 in the seventh row, and scan electrode SC8 in the eighth row. At the same time as this, positive address pulse voltage Vd is applied to data electrode Dk corresponding to the image signal to be displayed in the fifth to eighth rows, of data electrodes D1 to Dm. As a result, an address discharge is generated in main discharge cells C5, k to C8, k. The address discharge allows a positive wall voltage to be accumulated on scan electrodes SC5 to SC8 and a negative wall voltage to be accumulated on sustain electrodes SU5 to SU8 in main discharge cells C5, k to C8, k. This terminates the address operation in main discharge cells C5, 1 to C5, m; C6, 1 to C6, m; C7, 1 to C7, m; and C8, 1 to C8, m in the fifth to eighth rows, respectively.

Next, prior to the application of scan pulse voltage Va to scan electrode SC9 in the ninth row, negative priming pulse voltage Vp is applied simultaneously to priming electrodes PR9 and PR11 in the ninth and eleventh rows, respectively. Hereinafter, the address operation is repeated in the same manner.

Thus, in the panel driving method shown in FIG. 7, priming pulse voltage Vp is applied to two adjacent priming electrodes PRp and PRp+2 simultaneously so as to generate a priming discharge in two priming discharge cells PSp and PSp+2 simultaneously. The priming is supplied to four rows of main discharge cells Cp, 1 to Cp, m; Cp+1, 1 to Cp+1, m; Cp+2, 1 to Cp+2, m; and Cp+3, 1 to Cp+3, m which are adjacent to priming discharge cells PSp and PSp+2. Then, an address operation is sequentially performed in the main discharge cells that have been supplied with the priming (an address operation in main discharge cells Cp, 1 to Cp, m; Cp+1, 1 to Cp+1, m; Cp+2, 1 to Cp+2, m; and Cp+3, 1 to Cp+3, m). Next, prior to the application of address pulse voltage Va to scan electrode SCp+4 in the p+4 row, priming pulse voltage Vp is applied to priming electrodes PRp+4 and PRp+6 so as to generate a priming discharge in priming discharge cells PSp+4 and PSp+6. The generation of a priming discharge and the sequential address operation in the main discharge cells adjacent to the priming discharge cell are repeated for all the remaining main discharge cells.

The method for driving PDP 10 shown in FIG. 7 is used only in the case where the amount of priming remaining in the main discharge cells is enough for the period corresponding to at least four address pulses. However, the priming pulse voltage has only to be applied to the priming electrodes in one address period. This makes it unnecessary to provide the priming discharge cell initializing period, thereby reducing the sub-field period. Furthermore, priming pulse voltage Vp has to be applied only once to the same priming electrode in one address period, thereby reducing power consumption.

In the first embodiment, the initializing period of the first sub-field is where an all-cell initializing operation is performed to generate an initializing discharge in all main discharge cells. The initializing period of the subsequent sub-fields is where a selective initializing operation is performed to selectively initialize only the main discharge cells that have performed a sustain discharge. Alternatively, these initializing operations may be desirably combined.

In the first embodiment, priming pulse voltage Vp is applied to two adjacent priming electrode PRp and PRp+2 simultaneously, and then to the subsequent two priming electrodes PRp+4 and PRp+6 simultaneously. Instead of this, priming pulse voltage Vp may be applied, after being applied to priming electrodes PRp and PRp+2, to two priming electrodes PRp+2n and PRp+2(n+1) where “n” is an integer selected so as not to apply a priming pulse voltage to the same priming electrode in one address period. Priming electrodes PRp+2n and PRp+2(n+1) are arranged away from priming electrodes PRp and PRp+2.

In the first embodiment, adjacent priming electrodes PRp and PRp+2 are electrically connected to each other via connecting portions 38 as shown in FIG. 4, but may be connected in other ways as long as one priming electrode driving IC 107 can drive a plurality of priming electrodes.

FIG. 8 is a plan view showing the connection between priming electrodes 29 and priming electrode driving circuit 106 of another example of PDP 10 according to the first embodiment of the present invention. As shown in FIG. 8, there are no connecting portions 38 to electrically connect adjacent priming electrodes PRp and PRp+2, but one priming electrode driving IC 107 is electrically connected to a plurality of priming electrodes 29 via conductive lines 108 so as to perform the same driving as above.

In the first embodiment, priming pulse voltage Vp is applied to two adjacent priming electrodes PRp and PRp+2 simultaneously. Instead of this, a priming pulse voltage may be applied to three or more priming electrodes simultaneously from one priming electrode driving IC 107 in the following circumstances. A larger number of address operations can be performed in the residue time of priming, for example, because the address pulse can have a larger pulse width or because the residue time of the priming supplied to the main discharge cells can be longer. Alternatively, when the amount of priming remaining in the main discharge cells is enough for the period corresponding to three address pulses, the address operation can be performed as follows.

First, priming pulse voltage Vp is applied to three priming electrodes PRp, PRp+2, and PRp+4 simultaneously to generate a priming discharge in priming discharge cells PSp, PSp+2, and PSp+4 simultaneously. Next, an address discharge is sequentially generated in three rows of main discharge cells Cp, 1 to Cp, m; Cp+2, 1 to Cp+2, m; and Cp+4, 1 to Cp+4, m in the odd rows, of main discharge cells Cp, 1 to Cp, m; Cp+1, 1 to Cp+l, m; Cp+2, 1 to Cp+2, m; Cp+3, 1 to Cp+3, m; Cp+4, 1 to Cp+4, m; and Cp+5, 1 to Cp+5, m which are adjacent to priming discharge cells PSp, PSp+2, and PSp+4. After completion of the address operation in all main discharge cells in the odd rows, the priming discharge cells are initialized. Priming pulse voltage Vp is applied again to three priming electrodes PRp, PRp+2, and PRp+4 simultaneously so as to generate a priming discharge in priming discharge cells PSp, PSp+2, and PSp+4 simultaneously. Next, an address discharge is sequentially generated in three rows of main discharge cells Cp+1, 1 to Cp+1, m; Cp+3, 1 to Cp+3, m; and Cp+5, 1 to Cp+5, m in the even rows, of the main discharge cells Cp, 1 to Cp, m; Cp+1, 1 to Cp+1, m; Cp+2, 1 to Cp+2, m; Cp+3, 1 to Cp+3, m; Cp+4, 1 to Cp+4, m; and Cp+5, 1 to Cp+5, m. When the address operation in all the main discharge cells in the even rows is complete, the address operation in all the main discharge cells is complete.

Alternatively, when the amount of priming remaining in the main discharge cells is enough for the period corresponding to six address pulses, the address operation can be performed as follows. First, priming pulse voltage Vp is applied to three priming electrodes PRp, PRp+2, and PRp+4 simultaneously to generate a priming discharge in priming discharge cells PSp, PSp+2, and PSp+4 simultaneously. Next, an address discharge is sequentially generated in six rows of main discharge cells Cp, 1 to Cp, m; Cp+1, 1 to Cp+1, m; Cp+2, 1 to Cp+2, m; Cp+3, 1 to Cp+3, m; Cp+4, 1 to Cp+4, m; and Cp+5, 1 to Cp+5, m which are adjacent to priming discharge cells PSp, PSp+2, and PSp+4. These driving methods could reduce the number of priming electrode driving ICs 107 to one third the number of the priming electrodes. If one priming electrode driving IC can drive more priming electrodes, the number of the priming electrode driving ICs can be reduced accordingly.

### INDUSTRIAL APPLICABILITY

The present invention is useful as a PDP and a plasma display device which are used for wall-hung TVs, large-size monitors, and the like, and as a method for driving the PDP because of being capable of stably generating an address discharge without narrowing the driving voltage margin of an address operation and capable of reducing the number of driving circuits required for driving the priming electrodes.

1. A plasma display panel comprising:
a scan electrode and a sustain electrode together forming a display electrode pair, the scan electrode and the sustain electrode being parallel to each other on a first substrate;
a priming electrode between consecutive scan electrodes of the display electrode pairs on the first substrate, the priming electrode being parallel to the display electrode pair;
a data electrode on a second substrate, the second substrate facing the first substrate with a discharge space therebetween, the data electrode being in a direction intersecting with the display electrode pair; and
a barrier rib defining a main discharge cell in a position where the display electrode pair and the data electrode face each other, the barrier rib also defining a priming discharge cell in a position where the priming electrode and the data electrode face each other, wherein
at least two adjacent ones of the priming electrodes are electrically connected to each other.

2. A plasma display device comprising:
a plasma display panel comprising:
a scan electrode and a sustain electrode together forming a display electrode pair, the scan electrode and the sustain electrode being parallel to each other on a first substrate;
a priming electrode between consecutive scan electrodes of the display electrode pairs on the first substrate, the priming electrode being parallel to the display electrode pair;
a data electrode on a second substrate, the second substrate facing the first substrate with a discharge space therebetween, the data electrode being in a direction intersecting with the display electrode pair; and
a barrier rib defining a main discharge cell in a position where the display electrode pair and the data electrode face each other, the barrier rib also defining a priming discharge cell in a position where the priming electrode and the data electrode face each other, wherein
at least two adjacent ones of the priming electrodes are simultaneously applied with a priming pulse voltage.

3. A method for driving a plasma display panel in which one field includes a plurality of sub-fields each having an initializing period, an address period, and a sustain period, the plasma display panel comprising:
a scan electrode and a sustain electrode together forming a display electrode pair, the scan electrode and the sustain electrode being parallel to each other on a first substrate;
a priming electrode between consecutive scan electrodes of the display electrode pairs on the first substrate, the priming electrode being parallel to the display electrode pair;
a data electrode on a second substrate, the second substrate facing the first substrate with a discharge space therebetween, the data electrode being in a direction intersecting with the display electrode pair; and
a barrier rib defining main discharge cells in a position where the display electrode pair and the data electrode face each other, the barrier rib also defining a priming discharge cell in positions where the priming electrode and the data electrodes face each other,
the method comprising:
applying a priming pulse voltage simultaneously to the at least two adjacent priming electrodes in the address period; and
generating a priming discharge simultaneously in the at least two adjacent priming discharge cells.

4. The method for driving a plasma display panel of claim 3, comprising:
generating an address discharge sequentially to the main discharge cells in odd rows or in even rows, of at least four rows of the main discharge cells adjacent to the at least two priming discharge cells that have generated a priming discharge;
generating a priming discharge again in the at least two priming discharge cells that have generated the priming discharge; and
generating an address discharge sequentially.

5. The method for driving a plasma display panel of claim 3, comprising:
generating an address discharge sequentially in at least four rows of main discharge cells adjacent to the at least two priming discharge cells that have generated the priming discharge.

6. The method for driving a plasma display panel of claim 4, wherein
in the at least four rows of main discharge cells adjacent to the at least two priming discharge cells that have generated the priming discharge, an address pulse width, which sequentially generates the address discharge, increases with time after generation of the priming discharge.

7. The method for driving a plasma display panel of claim 3, wherein
after completion of the address period in all the main discharge cells, the sustain period starts simultaneously in all the main discharge cells.

8. The method for driving a plasma display panel of claim 5, wherein
in the at least four rows of main discharge cells adjacent to the at least two priming discharge cells that have generated the priming discharge, an address pulse width, which sequentially generates the address discharge, increases with time after generation of the priming discharge.

9. The method for driving a plasma display panel of claim 4, wherein
after completion of the address period in all the main discharge cells, the sustain period starts simultaneously in all the main discharge cells.

10. The method for driving a plasma display panel of claim 5, wherein
after completion of the address period in all the main discharge cells, the sustain period starts simultaneously in all the main discharge cells.
